(19) United States
(12) Patent Application Publication
(10) Pub. No.: US 2014/0280669 A1
(43) Pub. Date: Sep. 18, 2014

(54) Memory Sharing Over A Network

(71) Applicant: MICROSOFT CORPORATION, Redmond, WA (US)

(72) Inventors: David T. Harper, III, Seattle, WA (US); Sudipta Sengupta, Redmond, WA (US); Douglas Christopher Burger, Bellevue, WA (US); Eric C. Peterson, Woodinville, WA (US); David A. Maltz, Bellevue, WA (US)

(73) Assignee: MICROSOFT CORPORATION, Redmond, WA (US)

(21) Appl. No.: 13/831,753

(22) Filed: Mar. 15, 2013

(51) Int. Cl. G06F 15/167

(52) U.S. Cl. CPC G06F 15/167
USPC 709/213

(57) ABSTRACT

Memory is shared among physically distinct, networked computing devices. Each computing device comprises a Remote Memory Interface (RMI) accepting commands from locally executing processes and translating such commands into forms transmittable to a remote computing device. The RMI also accepts remote communications directed to it and translates those into commands directed to local memory. The amount of storage capacity shared is informed by a centralized controller, either a single controller, a hierarchical collection of controllers, or a peer-to-peer negotiation. Requests that are directed to remote high-speed non-volatile storage media are detected or flagged and the process generating the request is suspended such that it can be efficiently revived. The storage capacity provided by remote memory is mapped into the process space of processes executing locally.

### BACKGROUND

As the throughput of the communications between computing devices continues to increase, it becomes progressively less expensive to transfer data from one computing device to another. Consequently, server computing devices that are remotely located are increasingly utilized to perform large-scale processing, with the data resulting from such processing being communicated back to users through local, personal computing devices that are communicationally coupled, via computer networks, to such server computing devices.

Traditional server computing devices are, typically, optimized to enable a large quantity of such server computing devices to be physically co-located. For example, traditional server computing devices are often built utilizing a “blade” architecture, where the hardware of the server computing device is located within a physical housing that is physically compact and designed such that multiple such blades can be arranged vertically in a “rack” architecture. Each server computing device within a rack can be networked together, and multiple such racks can be physically co-located, such as within a data center. A computational task can then be distributed across multiple such server computing devices within the single data center, thereby enabling completion of the task more efficiently.

In distributing a computational task across multiple server computing devices, each of those multiple server computing devices can access a single set of data that can be stored on computer readable storage media organized in the form of disk arrays or other like collections of computer readable storage media that can be equally accessed by any of the multiple server computing devices, such as through a Storage Area Network (SAN), or other like mechanisms. A computational task can then be performed in parallel by the multiple server computing devices without the need to necessarily make multiple copies of the stored data on which such a computational task is performed.

Unfortunately, the processing units of each server computing device are limited in the amount of memory they can utilize to perform computational tasks. More specifically, the processing units of each server computing device can only directly access the memory that is physically within the same server computing device as the processing units. Virtual memory techniques are typically utilized to enable the processing of computational tasks that require access to a greater amount of memory than is physically installed on a given server computing device. Such virtual memory techniques can swap data from memory to disk, thereby generating the appearance of a greater amount of memory. Unfortunately, the swapping of data from memory to disk, and back again, often introduces unacceptable delays. Such delays can be equally present whether the disk is physically located on the same server computing device, or is remotely located, such as on another computing device, or as part of a SAN. More specifically, improving the speed of the storage media used to support such swapping does not resolve the delays introduced by the use of virtual memory techniques.

### SUMMARY

In one embodiment, memory that is physically part of one computing device can be mapped into the process space, of and be directly accessible by, processes executing on another, different computing device that is communicationally coupled to the first computing device. The locally addressable memory namespace of one computing device is, thereby, supported by memory that can physically be on another, different computing device.

In another embodiment, a Remote Memory Interface (RMI) can provide memory management functionality to locally executing processes, accepting commands from the locally executing processes that are directed to the locally addressable memory namespace and then translating such commands into forms transmittable over a communicational connection to a remote computing device whose physical memory supports part of the locally addressable memory namespace. The RMI can also accept remote communications directed to it and translate those communications into commands directed to locally installed memory.

In yet another embodiment, a controller can determine how much memory storage capacity to share with processes executing on other computing devices. Such a controller can be a centralized controller that can coordinate the sharing of memory among multiple computing devices, or it can be implemented in the form of peer-to-peer communications among the multiple computing devices themselves. As yet another alternative, such a controller can be implemented in a hierarchical format where one level of controllers coordinate the sharing of memory among sets of computing devices, and another level of controllers coordinate the sharing among individual computing devices in each individual set of computing devices.

In a further embodiment, should a locally executing process attempt to access a portion of the locally addressable memory namespace that is supported by physical memory on a remote computing device, such access can be detected or flagged, and the execution of a task generating such a request can be suspended pending the completion of the remote access of the data. Such a suspension can be tailored to the efficiency of such remote memory operations, which can be orders of magnitude faster then current virtual memory operations.

In a still further embodiment, operating systems of individual computing devices sharing memory can comprise functionality to adjust the amount of storage of such memory that is shared, as well as functionality to map, into the process space of processes executing on such computing devices, storage capacity supported by memory that is remote from the computing device on which such processes are executing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary memory sharing environment;

FIG. 2 is a block diagram of an exemplary architecture enabling memory sharing;

FIGS. 3a and 3b are flow diagrams of exemplary memory sharing mechanisms; and

FIG. 4 is a block diagram illustrating an exemplary general purpose computing device.

### DETAILED DESCRIPTION

The following description relates to memory sharing over a network. Memory can be shared among computing devices that are communicationally coupled to one another, such as via a network. Each computing device can comprise a Remote Memory Interface (RMI) that can provide memory management functionality to locally executing processes, accepting commands from the locally executing processes that are directed to the locally addressable memory namespace and then translating such commands into forms transmittable to a remote computing device. The RMI can also accept remote communications directed to it and translate those communications into commands directed to local memory. The amount of memory that is shared can be informed by a centralized controller, either a single controller or a hierarchical collection of controllers, or can be informed by peer-to-peer negotiation among the individual computing devices performing the memory sharing. Requests to access data that is actually stored on remote memory can be detected or flagged and the execution of the task of generating such a request can be suspended in such a manner that it can be efficiently revived, appropriate for the efficiency of remote memory access. An operating system can provide, to locally executing applications, a locally addressable memory namespace that include capacity that is actually supported by the physical memory of one or more remote computing devices. Such operating system mechanisms can also adjust the amount of memory available for sharing among multiple computing devices.

The techniques described herein make reference to the sharing of specific types of computing resources. In particular, the mechanisms describe are directed to the sharing of “memory”. As utilized herein, the term “memory” means any physical storage media that supports the storing of data that is directly accessible, to instructions executing on a central processing unit, through a locally addressable memory namespace. Examples of “memory” as that term is defined herein, include, but are not limited to, Random Access Memory (RAM), Dynamic RAM (DRAM), Static RAM (SRAM), Thyristor RAM (T-RAM), Zero-capacitor RAM (Z-RAM) and Twin Transistor RAM (TTRAM). While such a listing of examples is not limited, it is not intended to expand the definition of the term “memory” beyond that provided above. In particular, the term “memory”, as utilized herein, specifically excludes storage media that stores data accessible through a storage namespace or file system.

Although not required, aspects of the descriptions below will be provided in the general context of computer-executable instructions, such as program modules, being executed by a computing device. More specifically, aspects of the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional server computing racks or conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments linked through a communications network. In a distributed computing environment, program modules may be located in both local and remote storage devices.

With reference to FIG. 1, an exemplary system 100 is illustrated, comprising a network 190 of computing devices. For purposes of providing an exemplary basis for the descriptions below, three server computing devices, in the form of server computing devices 110, 120 and 130, are illustrated as being communicationally coupled to one another via the network 190. Each of the server computing devices 110, 120 and 130 can comprise processing units that can execute computer-executable instructions. In the execution of such computer executable instructions, data can be stored by the processing units into memory. Depending upon the computer-executable instructions being executed, the amount of data desired to be stored into memory can be greater than the storage capacity of the physical memory installed on a server computing device. In such instances, typically, virtual memory mechanisms are utilized, whereby some data is “swapped” from the memory to slower non-volatile storage media, such as a hard disk drive. In such a manner, more memory capacity is made available. When the data that was swapped from the memory to the disk is attempted to be read from the memory by an executing process, a page fault can be generated, and processing can be temporarily suspended while such data is read back from the slower disk and again stored in the memory, from which it can then be provided to the processing units. As will be recognized by those skilled in the art, such a process can introduce delays that can be undesirable, especially in a server computing context.

The exemplary system 100 of FIG. 1 illustrates an embodiment in which a server computing device 130 has been assigned a job 140 that can require the server computing device 130 to perform processing functionality. More specifically, one or more processing units, such as the central processing units (CPUs) 132 of the server computing device 130, can execute computer-executable instructions associated with the job 140. Typically, execution of the computer-executable instructions associated with the job 140 can require the storage of data in memory, such as the memory 135 of the server computing device 130. For purposes of the descriptions below, the amount of memory that the computer-executable instructions associated with the job 140 can require can exceed the amount of memory 135 or, more accurately, can exceed the memory storage capacity of the memory 135 that can be allocated to the processing of the job 140.

In the embodiment illustrated in FIG. 1, the CPU 132 of the server computing device 130, which can be executing the computer-executable instructions associated with the job 140, can communicate with one or more memory management units (MMUs), such as the MMU 133, in order to store data in the memory 135, and retrieve data therefrom. As will be recognized by those skilled in the art, typically, a STORE instruction can be utilized to store data in the memory 135 and a LOAD instruction can be utilized to read data from the memory 135 and load it into one or more registers of the CPU 132. Although illustrated separately, the MMU 133 is often an integral portion of the CPU 132. If, as indicated previously, in executing the computer-executable instructions associated with the job 140, the CPU 132 seeks to store additional data into memory beyond the memory capacity that is allocated to it, in one embodiment, such additional memory capacity can be made available as part of the locally addressable memory namespace through the functionality of the Remote Memory Interface (RMI) 131. More specifically, attempts by computer-executable instructions to access a portion of the locally addressable memory namespace can cause such access to be directed to the RMI 131, which can translate such access into network communications and can communicate with other, different, computing device, such as, for example, one of the server computing devices 110 and 120, and can, thereby utilize the physical memory installed on such other computing devices for the benefit of the processes executing on the computing device 130.

Thus, in one embodiment, a remote memory interface 131 can act as a memory management unit, such as the MMU 133, from the perspective of the CPU 132 and the computer-executable instructions being executed thereby. For example, a memory page table, or other like memory interface mechanism can identify specific portions of the locally addressable memory namespace, such as specific pages, or specific address ranges, that can be associated with the remote memory interface 131. A LOAD or STORE instruction, or other like instruction, directed to those portions of the locally addressable memory namespace can be directed to the remote memory interface 131. Thus, the locally addressable memory namespace, as utilizable by the processes being executed by the server computing device 130, can be greater than the physical memory 135 because the remote memory interface 131 can utilize the memory of remote computing devices, such as, for example, the memory 125 of the server computing device 120, or the memory 115 of the server computing device 110, to support an increased memory namespace on the computing device 130.

In such an embodiment, upon receiving a command, on the computing device 130, that is directed to the portion of the local memory namespace that is supported by the remote memory interface 131, the remote memory interface 131 can translate the command into a format that can be communicated over the network 190 to one or more other computing devices, such as the server computing devices 110 and 120. For example, the remote memory interface 131 can packetize the command in accordance with the packet structure defined by the network protocols utilized by the network 190. As another example, the remote memory interface 131 can generate appropriate network addressing information and other like routing information, as dictated by the protocols used by the network 190, in order to direct communications to the remote memory interfaces of specific computing devices such as, for example, the remote memory interface 121 of the server computing device 120, or the remote memory interface 111 of the server computing device 110.

Subsequently, the remote memory interfaces on those other computing devices, upon receiving network communications directed to them, can translate those network communications into appropriate memory-centric commands and carry out such commands on the memory that is physically present on the same computing device as the remote memory interface receiving such network communications. For example, upon receiving a communication from the remote memory interface 131, the remote memory interface 121, on the server computing device 120, can perform an action with respect to a portion 126 of the memory 125. The portion 126 of the memory 125 can be a portion that can have been set aside in order to be shared with other computing devices, such as in a manner that will be described in further detail below. In a similar manner, the remote memory interface 111, on the server computing device 110, can perform an action with respect to the portion 116 of the memory 115 of the server computing device 110 in response to receiving a communication, via the network 190, from the remote memory interface 131 of the server computing device 130. Although illustrated as a distinct physical portion, the portions 116 and 126 of the memory 115 and 125, respectively, are only intended to graphically illustrate that some of the memory storage capacity of the memory 115 and 125 is reserved for utilization by the remote memory interfaces of those computing devices, namely the remote memory interfaces 111 and 121, respectively. As will be recognized by those skilled in the art, no clear demarcation need exist between the actual physical data storage units, such as transistors, of the memory 115 and 125 that support the locally addressable memory namespace and those storage units that provide the memory storage capacity that is reserved for utilization by the remote memory interfaces 111 and 121, respectively.

To provide further description, if, for example, in executing the job 140, the CPU 132 of the server computing device 130 sought to store data into a portion of the locally addressable memory namespace that was supported by the remote memory interface 131, as opposed to the memory management unit 133, such a request can be directed to the remote memory interface 131, which can then translate the request into network communications that can be directed to the remote memory interface 121, on the server computing device 120, and the remote memory interface 111, on the server computing device 110. Upon receiving such network communications, the remote memory interface 121 can translate the network communications into the request to store data, and can then carry out the storing of the data into the portion 126 of the memory 125 of the server computing device 120. Similarly, upon receiving such network communications, the remote memory interface 111 can also translate the network communications into the request to store data, and can carry out the storing of that data into the portion 116 of the memory 115 of the server computing device 120. In such a manner, the memory namespace that is addressable by processes executing on the server computing device 130 can be greater than the memory 135 present on the server computing device 130. More specifically, and as will be described in further detail below, shared memory from other computing devices, such as the portion 126 of the memory 125 of the server computing device 120, and the portion 116 of the memory 115 of the server computing device 110 can support the memory namespace that is addressable by processes executing on the server computing device 130, such as, for example, the processes associated with the job 140, thereby enabling such processes to utilize more memory than is available from the memory 135 on the server computing device 130 on which such processes are executing.

In one embodiment, the amount of memory storage capacity that is made available for sharing can be coordinated by a centralized mechanism, such as the memory sharing controller 170. For example, the memory sharing controller 170 can receive information from computing devices, such as the exemplary server computing devices 110, 120 and 130, and can decide, based upon such received information, an amount of memory storage capacity of the server computing devices 110, 120 and 130 that is to be made available for sharing. For example, the memory sharing controller 170 can instruct the server computing device 120 to make the portion 126 of its memory 125 available for sharing. In a similar manner, the memory sharing controller 170 can instruct the server computing device 110 to make the portion 116 of its memory 115 available for sharing. In response, the operating system or other like memory controller processes of the server computing devices 110 and 120 can set aside the portions 116 and 126, respectively, of the memory 115 and 125, respectively, and not utilize those portions for processes executing locally on those server computing devices. More specifically, specific pages of memory, specific addresses of memory, or other like identifiers can be utilized to delineate the locally addressable memory namespace from the memory storage capacity that is reserved for utilization by a remote memory interface, and is, thereby, shared with processes executing on remote computing devices. Thus, for example, the locally addressable memory namespace that can be utilized by processes executing on the server computing device 120 can be supported by the portion of the memory 125 that excludes the portion 126 that is set aside for sharing. In a similar manner, the locally addressable memory namespace that can be utilized by processes executing on the server computing device 110 can be supported by the portion of the memory 115 that excludes the portion 116.

The information received by the memory sharing controller 170 from computing devices, such as exemplary server computing devices 110, 120 and 130, can include information specifying a total amount of memory physically installed on such computing devices, or otherwise available to such computing devices, an amount of memory storage capacity currently being utilized, a desired amount of memory storage capacity, and other like information. Based upon such information, the memory sharing controller 170 can identify an amount of memory storage capacity to be made available for sharing by each of the server computing devices 110, 120 and 130. In one embodiment, the memory sharing controller 170 can instruct the server computing devices 110, 120 and 130 accordingly, while, in other embodiments, the memory sharing controller 170 can merely issue requests that the operating systems, or other like control mechanisms, of individual computing devices can accept or ignore.

In one embodiment, the memory sharing controller 170 can continually adjust the amount of memory storage capacity being shared. In such an embodiment, the operating systems, or other like control mechanisms, of individual computing devices can comprise mechanisms by which the size of the locally addressable memory namespace can be dynamically altered during runtime. For example, execution of the job 140, by the server computing device 130, can result in an increased demand for memory. In response, processes executing on the server computing device 130 can communicate with the memory sharing controller 170 and can request additional shared memory. The memory sharing controller 170 can then, as an example, request that the server computing device 110 increase the portion 116 of the memory 115 that it has made available for sharing. In response, in one embodiment, the operating system or other like control mechanisms, executing on the server computing device 110, can swap data stored in those portions of the memory 115 that were previously assigned to processes executing locally on the server computing device 110, and store such data on, for example, a hard disk drive. Subsequently, those portions of the memory 115 can be added to the portion 116 that is available for sharing, thereby increasing the portion 116 that is available for sharing, and accommodating the increased needs of the execution of the job 140 on the server computing device 130. Should processes executing locally on the server computing device 110 then attempt to access those portions of the memory 115 that were previously assigned to such processes, which have subsequently been reassigned to the portion 116 that is being shared, a page fault can be generated, and virtual memory mechanisms can be utilized to move some other data from other portions of the memory 115 to disk, thereby making room to swap back into the memory 115 the data that was previously swapped out to disk.

In another embodiment, the memory sharing controller 170 can be limited in its adjustment of the portions of memory of the individual computing devices that are dedicated to sharing. For example, the memory sharing controller 170 may only be able to adjust the amount of memory being shared by any specific computing device during defined periods of time such as, for example, while that computing device is restarting, or during periods of time when that computing device has suspended the execution of other tasks.

Although the memory sharing controller 170 is indicated as a singular device, a hierarchical approach can also be utilized. For example, the memory sharing controller 170 can be dedicated to providing the above-described control of shared memory to server computing devices, such as exemplary server computing devices 110, 120 and 130, that are physically co-located, such as within a single rack of server computing devices, such as would be commonly found in a data center. Another, different memory sharing controller can then be dedicated to providing control of shared memory among another set of computing devices, such as, for example, among the server computing devices of another rack in the data center. A higher level memory sharing controller can then control the individual memory sharing controllers assigned to specific racks of server computing devices. For example, the rack-level memory sharing controllers can control the sharing of memory among the server computing devices within a single rack, while the data-center-level memory sharing controller can control the sharing of memory among the racks of server computing devices, leaving to the rack-level memory sharing controllers the implementation of such sharing at the individual server computing level.

In yet another embodiment, the memory sharing controller 170 need not be a distinct process or device, but rather can be implemented through peer-to-peer communications between the computing devices sharing their memory, such as, for example, the server computing devices 110, 120 and 130. More specifically, processes executing individually on each of the server computing devices 110, 120 and 130 can communicate with one another and can negotiate an amount of the memory 115, 125 and 135, respectively, of each of the server computing devices 110, 120 and 130 that is to be shared. Such locally executing processes can then instruct other processes, such as processes associated with the operating system's memory management functionality, to implement the agreed-upon and negotiated sharing.

Turning to FIG. 2, the system 200 shown therein illustrates an exemplary series of communications demonstrating an exemplary operation of remote memory interfaces in greater detail. For purposes of description, the processing unit 132 of the server computing device 130 are shown as executing computer-executable instructions associated with a job 140. As part of the execution of such computer-executable instructions the CPU 132 may seek to store or retrieve data from memory, such as that represented by the memory 135 that is physically installed on the server computing device 130. In the system 200 of FIG. 2, the locally addressable memory namespace 231 is shown, which, as will be understood by those skilled in the art, comprises memory that can be directly accessed by processes executing on the CPU 132 of the computing device 130. In one embodiment, and as will be described in further detail below, the locally addressable memory namespace 231 can include a portion 234 that can be supported by locally installed memory 135 and a portion that can be supported by the remote memory interface 131, and, in turn, remote memory. For example, if the computing device 130 comprises 16 GB of locally installed memory, then the portion 234 of the locally addressable memory namespace 231 can also be approximately 16 GB. Analogously, if the portion 235 of the locally addressable memory namespace 231 is 4 GB, then there can be 4 GB of shared memory on a remote computing device that can support that through the mechanisms described herein.

To store data into memory, the CPU 132 can issue an appropriate command, such as the well-known STORE command, which can be received by one or more memory management units 133, which can, in turn, interface with the memory 135 and store the data provided by the CPU 132 into appropriate storage locations, addresses, pages, or other like storage units in the physical memory 135. Similarly, to retrieve data from high-speed volatile storage media, the CPU 132 can issue another appropriate command, such as the well-known LOAD command, which can be received by the MMU 133, which can, in turn, interface with the physical memory 135, shown in FIG. 1, and retrieve the data requested by the CPU from appropriate storage locations and load such data into the registers of the CPU 132 for further consumption by the CPU 132 as part of the execution of the computer-executable instructions associated with the job 140. To the extent that the STORE and LOAD commands issued by the CPU 132 are directed to the portion 234 of the locally addressable memory namespace 231 that is supported by the locally installed memory 135, such STORE and LOAD commands, and the resulting operations on the memory 135, can be managed by the memory management unit 233, as graphically represented in the system 200 of FIG. 2 by the communications 221 and 222.

In one embodiment, the locally addressable memory namespace 231 can be greater than the memory installed on the computing device 130. In such an embodiment, the processes executing on the computing device 130, such as the exemplary job 140, can directly address the larger locally addressable memory namespace 231 and can have portions thereof mapped into the process space of those processes. Such a larger locally addressable memory namespace 231 can be supported by, not only the memory 135 that is installed on the server computing device 130, but can also by remote memory, such as the memory 125, which is physically installed on another, different computing device. The processes executing on the computing device 130, however, can be agnostic as to what physical memory is actually represented by the locally addressable memory namespace 231.

For example, computer-executable instructions associated with the job 140 can, while executing on the CPU 132, attempt to store data into the portion 235 of the locally addressable memory namespace 231 which, as indicated, such computer-executable instructions would recognize in the same manner as any other portion of the locally addressable memory namespace 231. The CPU 132 could then issue an appropriate command, such as the above-described STORE command, specifying an address, a page, or other like location identifier that identifies some portion of the locally addressable memory namespace 231 that is part of the portion 235. Such a command, rather than being directed to the MMU 133 can, instead, be directed to the remote memory interface 131. For example, a Translation Lookaside Buffer (TLB) or other like table or database could be referenced to determine that the location identifier specified by the memory-centric command issued by the CPU 132 is part of the portion 235, instead of the portion 234, and, consequently, such a command can be directed to the remote memory interface 131. In the exemplary system 200 of FIG. 2, such a command is illustrated by the communication 223 from the CPU 132 to the remote memory interface 131.

Upon receiving such a command, the remote memory interface 131 can translate such a command into network communications, such as the network communications 241, and address those network communications to remote memory interface on one or more other computing devices, such as, for example, the remote memory interface 121 of the server computing device 120. In translating the command 223 into the network communications 241, the remote memory interface 131 can packetize the command, or can otherwise generate network communications appropriate with the protocol being utilized to implement the network 190. For example, if the network 190 is implemented utilizing Ethernet hardware, than the remote memory interface 131 can generate network communications whose units do not exceed the maximum transmission unit for Ethernet. Similarly, if the network 190 is implemented utilizing the Transmission Control Protocol/Internet Protocol (TCP/IP), than the remote memory interface 131 can generate packets having TCP/IP headers and which can specify the IP address of the remote memory interface 121 as their destination. Other analogous translations can be performed depending on the protocols utilized to implement the network 190.

Once the network communications 241 are received by the remote memory interface 121 of the server computing device 120, to which they were directed, the remote memory interface 121 can translate such network communications 241 into an appropriate memory-centric command 251 that can be directed to the memory 125 installed on the server computing device 120. More specifically, the remote memory interface 121 can un-packetize the network communications 241 and can generate an appropriate memory-centric command 251 to one or more addresses in the portion 126 of the memory 125 that has been set aside as shareable memory and, consequently, can be under the control of the remote memory interface 121 as opposed to, for example, memory management units of the computing device 120 and, as such, can be excluded from the locally addressable memory namespace that is made available to the processes executing on the computing device 120.

In response to the memory-centric command 251, the remote memory interface 121 can receive an acknowledgment, if the command 251 was a STORE command, or can receive the requested data if the command was a LOAD command. Such a response is illustrated in the system 200 of FIG. 2 by the communications 252, from the portion 126 of the memory 125, to the remote memory interface 121. Upon receiving the response communications 252, the remote memory interface 121 can translate them into the network communication 242 that it can direct to the remote memory interface 131 from which it received the communication 241. As described in detail above with reference to the remote memory interface 131, the remote memory interface 121, in translating the communication 252 into the network communication 242, can packetize, package, format, or otherwise translate the communication 252 into network communication 242 in accordance with the protocols utilized to implement the network 190.

When the remote memory interface 131 receives the network communication 242, it can un-packetize it and can generate an appropriate response to the CPU 132, as illustrated by the communication 225. More specifically, if the communication 223, from the CPU 132, was a STORE command, than the communication 225 can be an acknowledgment that the data was stored properly, although, in the present example, such an acknowledgment is that the data was actually stored properly in the portion 126 of the memory 125 of the server computing device 120. Similarly, if the communication 223, from the CPU 132, was a LOAD command, than the communication 225 can be the data that the CPU 132 requested be loaded into one or more of its registers, namely data that was read from, in the present example, the portion 126 of the memory 125.

In such a manner, processes executing on the server computing device 130 can, without their knowledge, and without any modification to such processes themselves, utilize memory installed on other computing devices such as, for example, the memory 125 of the computing device 120. More specifically, the remote memory interface 131 acts as a memory management unit communicating with memory that appears to be part of the locally addressable memory namespace 231 that can be directly addressed by processes executing on the server computing device 130.

To reduce the latency between the receipt of the command 223 and the provision of the response 225, in one embodiment, the remote memory interface 131 can communicate directly with networking hardware that is part of the server computing device 130. For example, the remote memory interface 131 can be a dedicated processor comprising a direct connection to a network interface of the server computing device 130. Such a dedicated processor can be analogous to well-known Memory Management Unit processors (MMUs), which can be either stand-alone processors, or can be integrated with other processors such as one or more CPUs. The remote memory interface 121 can also be a dedicated processor comprising a direct connection to a network interface of the server computing device 120, thereby reducing latency on the other end of the communications.

In another embodiment, functionality described above as being provided by the remote memory interface 131 can be implemented in an operating system or utility executing on the server computing device 130. Similarly, the functionality described above as being provided by the remote memory interface 121, can likewise be implemented in an operating system or utility executing on the server computing device 120. In such an embodiment, communications generated by such a remote memory interface, and directed to it, can pass through a reduced network stack to provide reduced latency. For example, the computer-executable instructions representing such remote memory interface to be provided with direct access to networking hardware, such as by having built-in drivers or appropriate functionality.

As will be recognized by those skilled in the art, the above-described mechanisms differ from traditional virtual memory mechanisms and are not simply a replacement of the storage media to which data is swapped from memory. Consequently, because the response 225 can be provided substantially more quickly then it could in a traditional virtual memory context, a lightweight suspend and resume can be applied to the executing processes issuing commands such as the command 223. More specifically, and as will be recognized by those skilled in the art, in virtual memory contexts, when data is requested from memory that is no longer stored in such memory, and has, instead, been swapped to disk, execution of the requesting process can be suspended until such data is swapped back from the slower disk into memory. When such a swap is complete, the requesting process can be resumed and the requested data can be provided to it, such as, for example, by being loaded into the appropriate registers of one or more processing units. But with the mechanisms described above, data can be obtained from remote physical memory substantially more quickly than it could be swapped from slower disk media, even disks that are physically part of a computing device on which such processes are executing. Consequently, a lightweight suspend and resume can be utilized to avoid unnecessary delay in resuming a more completely suspended execution thread or other like processing.

For example, in one embodiment, the command 223 can be determined to be directed to the addressable remote memory 235 based upon the memory address, page, or other like location identifying information that is specified by the command 223 or to which the command 223 is directed. In such an embodiment, if it is determined that the command 223 is directed to the portion 235 of the locally addressable memory namespace 231 that is supported by remote memory, the process being executed by the CPU 132 can be placed in a suspended state from which it can be resumed more promptly than from a traditional suspend state. More specifically, the process that is being executed can itself determine that the command 223 is directed to the portion 235 based upon the memory location specified by the executing process. Consequently, the executing process can automatically place itself into a suspended state from which can be resumed more promptly than from a traditional suspend state. Alternatively, such a determination can be made by the CPU 132 or other like component which has the capability to automatically place the executing process into a suspended state.

In another embodiment, the remote memory interface 131, or another memory management component, can detect that the command 223 is directed to the portion 235 and can notify the executing process accordingly. More specifically, and as indicated previously, the memory locations to which the command 223 is directed can be detected and, from those memory locations, a determination can be made as to whether the command 223 is directed to the portion 235. If the determination is made that the command 223 is directed to the portion 235, a notification can be generated, such as to the executing process, or to process management components. In response to such a notification, the executing process can place itself in a suspended state from which can be resumed more promptly than from a traditional suspend state, or it can be placed into the suspended state, depending upon whether the notification was provided to the executing process directly or to process management components.

Turning to FIGS. 3a and 3b, the flow diagrams 301 and 302 shown therein, respectively illustrate an exemplary series of steps by which memory that is physically installed on a remote computing device can be utilized by locally executing processes. Turning first to FIG. 3a, initially, at step 310, network communications addressed to the local remote memory interface can be received. Once received, those network communications can be assembled into an appropriate network-centric command, such as the LOAD command or the STORE commands mentioned above. Such an assembly can occur as part of step 315 and, as indicated previously, can entail unpackaging the network communications from whatever format was appropriate given the network protocols through which communications among the various computing devices have been established. At step 320, the appropriate command can be performed with local memory. For example, if the received command was a STORE command specifying data to be stored starting at a particular memory address then, at step 320, such data could be stored in local memory starting at an address, or other like memory location, that is commensurate with the address specified by the received command. Similarly, if the received command was a LOAD command requesting the data that has been stored in the local memory starting at a specified address, or other like memory location, then, at step 320, the data stored in the commensurate locations of the local memory can be obtained. In one embodiment, the received command can specify the address that is to be utilized in connection with the local memory, while, in another embodiment, the address specified by the received command can be translated in accordance with the range of addresses, pages, or other locations that have been defined as the memory to be shared.

The performance, at step 320, of the requested command can result in a response such as, for example, an acknowledgement response if data was stored into the local memory, or response comprising the data that was requested to be read from the local memory. Such a response can be received at step 325. At step 330 such a response can be translated into network communications, which can then be directed to the remote memory interface of the computing device from which the network communications received at step 310 were received. As indicated previously, the translation of the response, at step 330, into network communications can comprise packetizing the response in accordance with the network protocols being implemented by the network through which communications with other computing devices have been established, including, for example, applying the appropriate packet headers, dividing data into sizes commensurate with a maximum transmission unit, providing appropriate addressing information, and other like actions. The network communications, once generated, can be transmitted, at step 335, to the remote memory interface of the computing device from which the network communications were received at step 310. The relevant processing can then end at step 340.

Turning to FIG. 3b, an analogous set of steps can commence, at step 350, with the receipt of a memory-centric command, such as a LOAD or STORE command, from a local process that is directed to a locally addressable memory namespace. The request can specify one or more addresses, or other like location identifiers, in the locally addressable memory namespace. As an initial matter, therefore, in one embodiment, at step 355, a check can be made as to whether the addresses specified by the memory centric command of step 350 are in an address range that is supported by a remote memory interface, such as that described in detail above. If, at step 355, it is determined that the memory-centric command is directed to addresses that are in a range of addresses of the locally addressable memory namespace that is supported by locally installed memory, then the processing relevant to remote memory sharing can end at step 385, as shown in the flow diagram 302. Conversely, however, if, at step 355, it is determined that memory-centric command is directed to addresses that are in a range of addresses of the locally addressable memory namespace that is supported by the remote memory interface, then processing can proceed with step 360.

At step 360, the address to which the request received at step 350 was directed, can be translated into an identification of one or more remote computing devices whose memory is used to store the data to which the request is directed. More specifically, in one embodiment, each time the remote memory interface receives a STORE command and stores data in the memory of a remote computing device, such as in the manner described in detail above, the remote memory interface can record an association between the address, of the locally addressable memory namespace to which the STORE command was directed, and an identifier, such as a network address, of the remote computing device into whose memory such data was ultimately stored. Subsequently, when a LOAD command is issued, from a locally executing process, for the same address in the locally addressable memory namespace, the remote memory interface can reference the previously recorded association, and determine which remote computing device it should communicate with in order to get that data. Additionally, in one embodiment, when receiving a STORE command for a particular address, in the locally addressable memory namespace, for the first time the remote memory interface can seek to store such data into the shared memory of a remote computing device that can be identified to the remote memory interface by the memory sharing controller, or which can be selected by the remote memory interface from among computing devices identified by the memory sharing controller. Once the remote computing device is identified, at step 360, processing can proceed with step 365. At step 365, the request received at step 350 can be translated into network communications that can be addressed to the remote memory interface identified of the computing device identified at step 360. As indicated previously, such a translation can comprise packetizing the request and otherwise generating a data stream in accordance with the protocols utilized by the network through which communications will be carried between the local computing device and the remote computing device comprising the memory.

In response to the transmission, at step 365, responsive network communications directed to the remote memory interface on the local computing device can be received at step 370. At step 375 those network communications can be assembled into a response to the request that was received at step 350, such as in the manner described in detail above. At step 380 such a response can be provided to the executing process that generated the request that was received at step 350. The relevant processing can then end at step 385.

Turning to FIG. 4, an exemplary computing device is illustrated, which can include both general-purpose computing devices, such as can execute some of the mechanisms detailed above, and specific-purpose computing devices, such as the switches described above. The exemplary computing device 400 can include, but is not limited to, one or more central processing units (CPUs) 420, a system memory 430 and a system bus 421 that couples various system components including the system memory to the processing unit 420. The system bus 421 may be any of several types of bus structures including a memory bus or memory controller, a peripheral bus, and a local bus using any of a variety of bus architectures. Depending on the specific physical implementation, one or more of the CPUs 420, the system memory 430 and other components of the computing device 400 can be physically co-located, such as on a single chip. In such a case, some or all of the system bus 421 can be nothing more than communicational pathways within a single chip structure and its illustration in FIG. 4 can be nothing more than notational convenience for the purpose of illustration.

The computing device 400 also typically includes computer readable media, which can include any available media that can be accessed by computing device 400. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

When using communication media, the computing device 400 may operate in a networked environment via logical connections to one or more remote computers. The logical connection depicted in FIG. 4 is a general network connection 471 to the network 190, which can be a local area network (LAN), a wide area network (WAN) such as the Internet, or other networks. The computing device 400 is connected to the general network connection 471 through a network interface or adapter 470 that is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 471. It will be appreciated that the network connections shown are exemplary and other means of establishing a communications link between computing devices may be used.

The computing device 400 may also include other removable/non-removable, volatile/nonvolatile computer storage media. By way of example only, FIG. 4 illustrates a hard disk drive 441 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers here to illustrate that, at a minimum, they are different copies.

As can be seen from the above descriptions, mechanisms for sharing memory among multiple, physically distinct computing devices has been presented. Which, in view of the many possible variations of the subject matter described herein, we claim as our invention all such embodiments as may come within the scope of the following claims and equivalents thereto.

We claim:

1. A method of sharing memory storage capacity among multiple computing devices, the method comprising the steps of:
receiving, at a first computing device, from a process executing on the first computing device, a memory-centric request specifying a memory address in a locally addressable memory namespace of the first computing device;
determining, at the first computing device, that the specified memory address is supported by memory installed on a second computing device;
translating, at the first computing device, the received request into network communications directed to the second computing device;
receiving, at the first computing device, network communications from the second computing device;
translating, at the first computing device, the received network communications from the second computing device into a response to the request; and
providing, at the first computing device, the response to the process.

2. The method of claim 1, further comprising the steps of:
receiving, at the second computing device, the network communications directed to the second computing device;
translating, at the second computing device, the network communications directed to the second computing device into a memory-centric request;
performing, at the second computing device, the memory-centric request on a portion of the memory installed on the second computing device;
receiving, at the second computing device, a response to the performance of the memory-centric request on the portion of the memory installed on the second computing device; and
translating, at the second computing device, the response to the performance of the memory-centric request into the network communications from the second computing device.

3. The method of claim 1, wherein the determining comprises referencing a Translation Lookaside Buffer (TLB), the TLB identifying memory addresses of the locally addressable memory namespace of the first computing device that are supported by memory installed on one or more remote computing devices.

4. The method of claim 1, wherein the translating the received request into the network communications comprises packetizing the received request in accordance with networking protocols utilized to establish a communicational connection between the first and second computing devices; and wherein further the translating the received network communications comprises un-packetizing the received network communications in accordance with the networking protocols.

5. The method of claim 1, wherein the translating the received request into the network communications directed to the second computing device comprises addressing the network communications directly to a remote memory interface of the second computing device.

6. The method of claim 1, further comprising the steps of suspending the process in response to the determining.

7. The method of claim 1, further comprising the steps of notifying the process, in response to the determining, that the memory-centric request is directed to a portion of the locally addressable memory namespace of the first computing device that is supported by memory of a computing device remote from the first computing device.

8. The method of claim 1, further comprising the steps of: identifying a portion of a memory of the first computing device that is to be shared among the multiple computing devices; and preventing the identified portion of the memory of the first computing device from being part of the locally addressable memory namespace of the first computing device.

9. The method of claim 8, wherein the identifying is performed in response to communications received from a memory sharing controller coordinating the sharing of the memory storage capacity among the multiple computing devices.

10. The method of claim 8, wherein the identifying is performed in response to a peer-to-peer negotiation among the multiple computing devices.

11. The method of claim 8, further comprising the steps of:
receiving, at the first computing device, a second network communications from the second computing device;
translating, at the first computing device, the received second network communications from the second computing device into a second memory-centric request specifying a second memory address, the second memory address being associated with the identified portion of the memory of the first computing device;
performing, at the first computing device, the second memory-centric request with reference to the identified portion of the memory of the first computing device; and
translating, at the first computing device, a second response, received in response to the performance of the second memory-centric request, into a second network communications directed to the second computing device.

12. The method of claim 11, wherein the second memory address is part of the identified portion of the memory of the first computing device.

13. The method of claim 11, further comprising the steps of: translating the second memory address into a corresponding address that is part of the identified portion of the memory of the first computing device.

14. A system sharing memory storage capacity among multiple computing devices, the system comprising:
a first computing device comprising:
a first locally addressable memory namespace;
a first memory;
a first remote memory interface; and
a first process executing on the first computing device; and
a second computing device physically distinct from the first computing device, the second computing device comprising:
a second operating system;
a second memory, a portion of which is available for sharing with other computing devices of the system, the portion being delineated by the second operating system; and
a second remote memory interface having direct access to the portion of the second memory;
wherein the first locally addressable memory namespace is supported by both the first memory of the first computing device and by the portion of the second memory of the second computing device.

15. The system of claim 14, wherein the first remote memory interface performs steps comprising:
receiving, from the first process, a memory-centric request specifying a memory address in the first locally addressable memory namespace;
determining that the specified memory address corresponds to a portion of the first locally addressable memory namespace that is supported by the portion of the second memory;
translating the received request into network communications directed to the second computing device;
receiving network communications from the second computing device;
translating the received network communications from the second computing device into a response to the request; and
providing, the response to the first process.

16. The system of claim, 14 further comprising a first memory sharing controller, the first memory sharing controller determining a portion of the first memory and the portion of the second memory that are to be made available for sharing.

17. The system of claim 16, further comprising:
a third computing device physically distinct from the first and second computing devices, the third computing device comprising a third memory;
a fourth computing device physically distinct from the first, second and third computing devices, the fourth computing device comprising a fourth memory;
a second memory sharing controller, the second memory sharing controller determining a portion of the third memory and a portion of the fourth memory that are to be made available for sharing; and
a third memory sharing controller, the third memory sharing controller directing the first memory sharing controller and the second memory sharing controller.

18. The system of claim 14, wherein the portion of the second memory made available for sharing with other computing devices was determined based upon a peer-to-peer negotiation between the first computing device and the second computing device.

19. A remote memory interface unit physically installed on a first computing device, the remote memory interface unit being configured to perform steps comprising:
receiving, from a process executing on the computing device, a memory-centric request specifying a memory address in a locally addressable memory namespace of the first computing device, the locally addressable memory namespace being supported both by a first memory installed on the first computing device and a portion of a second memory installed on a second computing device;
determining, that the specified memory address corresponds to the portion of the second memory installed on the second computing device, the second computing device being remote from the first computing device;
translating, the received request into network communications directed to the second computing device;
receiving, network communications from the second computing device;
translating, the received network communications from the second computing device into a response to the request; and
providing, the response to the process.

20. The remote memory interface unit of claim 19, further comprising a physical communicational connection to networking hardware communicationally coupling the first computing device to the second computing device.
